(19) United States
(12) Patent Application Publication
(10) Pub. No.: US 2014/0286743 A1
(43) Pub. Date: Sep. 25, 2014

(54) User Pay Waste Disposal Device and System

(71) Applicant: Erik Duivenvoorde, Qualicum Beach (CA)

(72) Inventor: Erik Duivenvoorde, Qualicum Beach (CA)

(21) Appl. No.: 14/356,134

(22) PCT Filed: Dec. 3, 2012
(86) PCT No.: PCT/CA2012/001121

§ 371 Date: May 2, 2014

Related U.S. Application Data
(60) Provisional application No. 61/566,048, filed on Dec. 2, 2011.

(51) Int. Cl. G07F 17/00

(52) U.S. Cl. CPC G07F 17/0014
USPC 414/810; 194/205

(57) ABSTRACT

A user pay waste disposal container, having a waste receiving compartment; a waste entry door into the waste receiving compartment; locking means for reversibly locking the waste entry door; and payment means for unlocking the waste entry door. The container may have a waste storage compartment adjacent the waste receiving compartment; and waste transfer means for transferring the waste from the receiving compartment to the storage compartment. A waste disposal system and method using the user pay containers distributed in a network of locations accessible to users for waste disposal.

### FIELD OF THE INVENTION

The present invention relates to waste disposal. In particular, the present invention relates to a waste disposal device and system which requires user payment at time of use.

### SUMMARY OF THE INVENTION

According to one of its aspects, the invention is a user pay waste disposal container, comprising a waste receiving compartment; a waste entry door into the waste receiving compartment; locking means for reversibly locking the waste entry door; and payment means for unlocking the waste entry door. The container may further comprise a waste storage compartment adjacent the waste receiving compartment; and waste transfer means for transferring the waste from the receiving compartment to the storage compartment. The waste transfer means may be rotation of the receiving compartment caused by closing of the waste entry door.

The container may have waste compaction means within the waste storage compartment for compacting received waste, as well as one or more waste vehicle lifting arm receptacles 20 on one or more outer surfaces 22.

The payment activated means may be one or more of coin-operated payment, pre-paid token operated payment, currency payment, credit card payment, debit card payment, pre-paid cash card payment, smart card reader payment, smart phone wireless payment, and third party billing payment.

The receiving compartment may have a volume sufficient to receive up to 80 cubic yards of waste, or up to 20 cubic yards of waste, or up to 1 cubic yard of waste, or other volume.

According to another of its aspects, the invention provides a user pay waste disposal system comprising a plurality of the user pay waste disposal containers as described herein, a network of container access sites, and one or more waste disposal vehicles for removal of waste from containers at each access site for transport to a landfill or other waste receiving site.

According to another of its aspects, the invention is a method of waste disposal comprising distributing one or more of the user pay waste disposal containers of claim 1 to one or more container access sites; allowing users to deposit a permitted volume of waste into a container through payment of a tariff by a selected mode of payment at the container; compacting and storing the deposited waste within the container; transferring the stored waste into a waste disposal vehicle; and transporting the waste to a landfill or other waste receiving site.

### BRIEF DESCRIPTION OF THE DRAWINGS

A detailed description of the preferred embodiments is provided below by way of example only and with reference to the following drawings, in which:

FIG. 1 is a front view of a preferred embodiment of the waste disposal container of the present invention; and

FIG. 2 is a cross-section through line 2-2 of FIG. 1 of a preferred embodiment of the user pay waste disposal device of the present invention, with the lockable door in a closed and locked position.

FIG. 3 is a cross-section through line 2-2 of FIG. 1 of a preferred embodiment of the user pay waste disposal device of the present invention, with the lockable door in an open and unlocked position.

In the drawings, one embodiment of the invention is illustrated by way of example. It is to be expressly understood that the description and drawing are only for the purpose of illustration and as an aid to understanding, and are not intended as a definition of the limits of the invention.

### DETAILED DESCRIPTION OF THE INVENTION

While it is known to provide containers for waste disposal, and to provide means for locking and unlocking such containers, it is not known to provide lock systems which are payment-operated in a waste disposal unit or as a retrofit to a waste disposal unit.

There is provided a waste disposal system wherein a variety of direct user pay waste disposal units may be installed on location for residential, commercial, industrial, institutional or other waste producing clients.

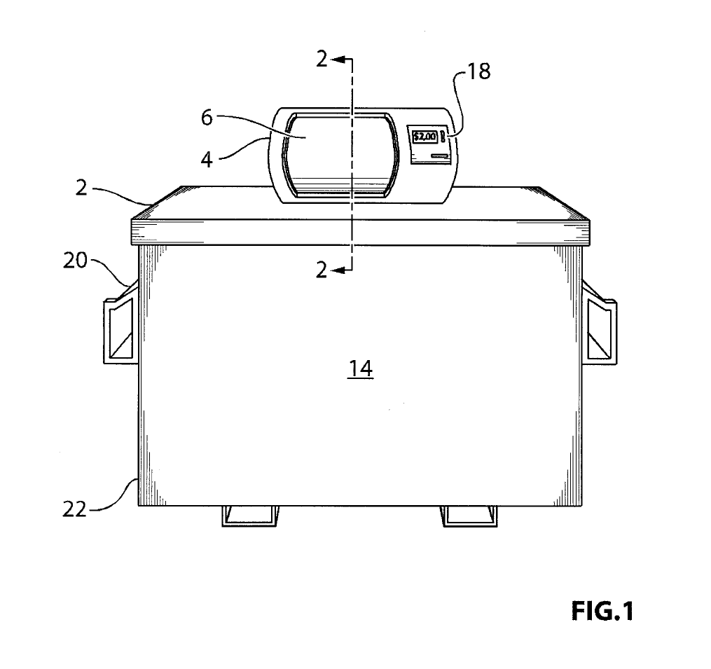

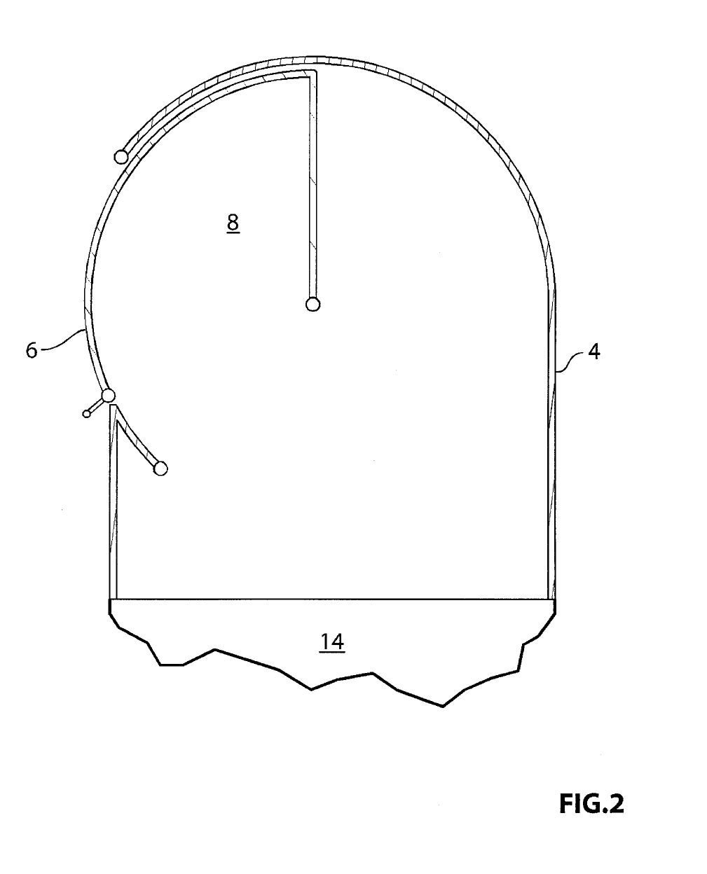

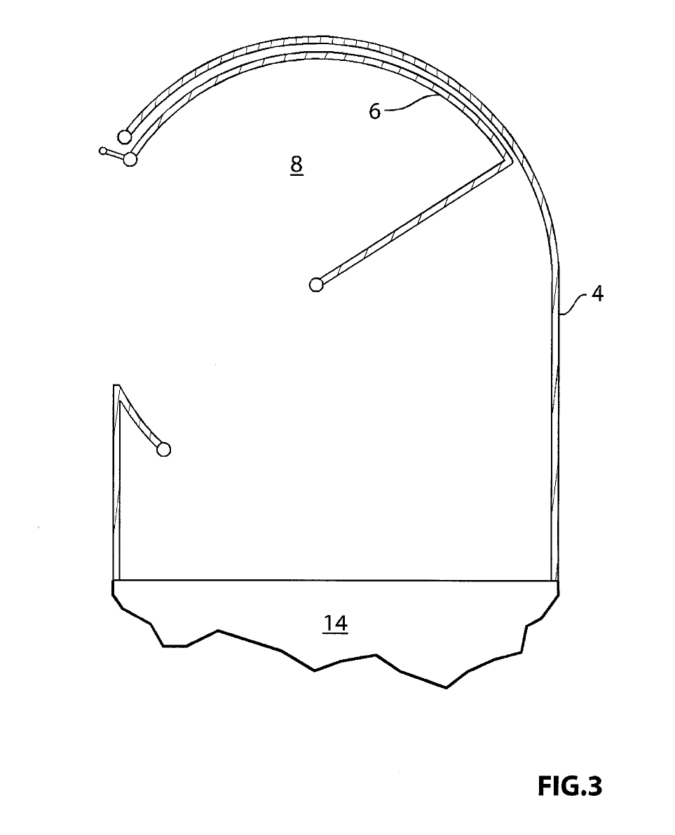

According to one embodiment of the present invention as shown in FIG. 1, the equipment may be a combination of a waste disposal unit 2 and a lockable waste receiving compartment 4 openable upon user payment. According to an alternate embodiment of the invention depicted in FIGS. 2 and 3, there is provided a user pay lockable waste receiving compartment 16 which may be attached to a waste disposal container.

In both embodiments, access to the waste disposal chamber is achieved by unlocking of a door 6 to the chamber only when payment is received. Once the door is open as shown in FIG. 2, waste may be placed into the waste receiving compartment 8. When the door is closed, it automatically locks and the waste is compacted into the waste storage compartment 14 of the waste container, in a similar manner to conventional waste disposal machines with loading chambers.

According to another embodiment of the present invention, a non-compacting waste disposal unit comprising a pay operated locking system 18 is provided. In this embodiment, a user effects payment for disposal, causing the access door to the unit to unlock. After insertion of the waste, the door automatically closes and locks using a spring mechanism or similar self-closing mechanism. To limit the volume of waste inserted, a two part compartment may be used, in which the user inserts waste into a smaller receiving compartment upon payment, and the inserted waste is dropped into a larger storage compartment after the door closes and locks, the locking mechanism triggering release of the waste into the storage compartment. Larger volumes of waste could be disposed of through repeated payments.

As well as the described self-closing mechanism of the waste container, according to another embodiment, a manual closing mechanism may be incorporated. In such a system, the manual closing of the container door would trigger a release of the waste from the receiving compartment into the storage compartment.

The locking means may be any latch or other prior art locking means which is locked when the door is in a closed position. The locking means are unlocked through activation of the payment means. Reclosing of the waste entry door locks the waste entry door.

According to another embodiment of the invention, existing prior art waste disposal equipment may be retrofitted to incorporate the payment apparatus and locking mechanisms of the present invention. The figures depict several prior art waste disposal containers which may be retrofitted to permit access restricted to paying users.

A wide variety of payment options may be incorporated into the system. The equipment of the present invention may be coin-operated, pre-paid token operated, or may permit payment with currency, credit cards, debit cards, pre-paid cash cards, smart phone wireless payment, third party billing, or through other electronic payment means known in the prior art. In one embodiment, user and equipment usage data and billing data may be compiled, permitting periodic billing and other services.

The combination of user pay access and waste disposal produces unexpected results. For example, waste may be retained at a user's site for a longer period of time, particularly if the waste is compacted. As such, there may be a need for a fully sealed waste disposal container which is leak proof for liquids as well as odours and other gases. The equipment of the present invention is suitable for waste disposal systems where resistance to animal tampering is important, reducing problems caused by bears, racoons, rats and other species. In addition, the equipment is sealed and leak proof, preventing environmental contamination and reducing cleanup requirements. The user pay disposal system also permits monitoring of waste disposal for environmental, financial or other purposes.

The operation of the waste disposal system by users other than waste disposal personnel requires improvements in safety. The apparatus of the present invention is safe for use by untrained users. Users are not exposed to moving parts, as the access door must be closed and locked before the machine begins to compact the waste. The locked door also prevents operation of the waste disposal unit unless payment has been received. As such, it is an ideal user pay waste disposal solution for centralized locations such as parking lots outside department, wholesale, hardware, and other stores.

There are a wide variety of applications for the present invention. The system may be used in apartment buildings, campgrounds, industrial sites, parks, and municipal sites. Also, units could be installed on demand on a permanent or temporary basis. Other applications could include use in retail malls and wholesale store parking lots which could provide the present invention as a waste vending machine for easy access by paying users.

The waste disposal units of the present invention may be manufactured as operable units, or existing waste disposal units may be retrofitted to include apparatus for payment and door locking. Examples of the types of waste disposal units included in the invention are roll off containers, and compactors. A variety of container sizes are possible, including 12, 20, 30, 40, 50, and 60 cubic yard containers. Other container sizes are also possible and included within the scope of the invention. The waste receiving compartment may range in size between a size which will hold one bag or less, to a size which would hold 6 bags or more, or other volume. The size of the lockable door and chamber opening may vary in accordance with the size of the chamber.

The invention also includes front loading Verta pack compactors of various sizes, including 3, 4, 6, and 8 cubic yard volumes. The size of the receiving compartment may be selected to permit loading of any desired amount of waste. For example, the chamber may be sized to permit loading of 1 bag or less, 6 or more household garbage bags, or other volume of waste.

The waste disposal system of the present invention offers several environmental benefits. The storage compartment of the device is never directly open to the outside, and the smaller waste receiving compartment is only open to the outside when the door is opened to deposit waste. As such, the waste is not accessible to animals or people, preventing tampering or injury. Another benefit is odour reduction over prior art waste disposal equipment. By providing a sealed, leak-proof self-locking container, odours are trapped within the container when the container is in it the closed state.

As indicated, trucking requirements are greatly reduced, generating significant environmental benefits, including a smaller carbon footprint. Where a frontload waste disposal container is being replaced by a verta pack or roll off container of the present system, even less trucking is required. The waste compacting function of the system of the present invention reduces the volume of waste to result in reduced trucking requirements.

In one embodiment, messages may be conveyed to a user, for example, inviting contributions to environmental organizations and educating users that there is a cost associated with waste disposal.

A further environmental benefit will be an overall reduction in disposed waste, as users will pay directly for disposing of waste. In response, users will have incentive to divert waste into recycling and compost. In addition, the equipment of the present invention will be selected to be durable to extend the useful life of the waste disposal units.

Among the benefits of the system of the present invention is a reduction in waste transportation requirements. To the extent that the compactor units of the present invention replace non-compactor containers, there will be a reduction in the number of truck trips required to transport the denser, compacted waste. In operation, the waste disposal system of the present invention could eliminate door to door waste collection, in favour of installation of the waste disposal units at selected sites for public use.

Similarly, households would be able to dispose of some waste at nearby parking lots or other community sites, rather than transporting their excess waste to a distant landfill, thereby reducing traffic and associated emissions and fuel use.

As the waste disposal units are maintained in a locked state, illegal dumping and tampering will be greatly reduced. In particular, identity theft will be prevented, and individuals will be unable to scavenge or sleep in the waste disposal units, thereby reducing risk of harm.

Owners or leasors of the equipment of the present invention would be able to generate revenue from users of their equipment, whether legitimate users such as residents of an apartment complex, or illegitimate users such as non-residents. Such outside use, while in the past considered to be a nuisance and a cost, will become a source for revenue for the equipment operators.

In another embodiment, a user pay waste disposal device may be installed on each floor of an apartment or office tower for ease of access by residents, workers, or custodial staff.

From the foregoing, it will be seen that this invention is one well adapted to attain all of the ends and objectives herein set forth, together with other advantages which are obvious and which are inherent to the apparatus. It will be understood that certain features and sub-combinations are of utility and may be employed with reference to other features and sub-combinations. As many possible embodiments may be made of the invention without departing from the scope of the claims, it is to be understood that all matter herein set forth or shown in the accompanying drawings is to be interpreted as illustrative and not in a limiting sense. It will be appreciated by those skilled in the art that other variations of the preferred embodiment may also be practised without departing from the scope of the invention.

1. A user pay waste disposal container, comprising:
a. a waste receiving compartment;
b. a waste entry door into the waste receiving compartment, wherein the waste entry door forms the upper sides of the waste receiving compartment;
c. locking means for reversibly locking the waste entry door; and
d. payment means for unlocking the locking means.

2. The container of claim 1, further comprising:
a. a waste storage compartment adjacent the waste receiving compartment; and
b. waste transfer means for transferring the waste from the receiving compartment to the storage compartment.

3. The container of claim 2, wherein the waste transfer means is the rotation of the receiving compartment caused by closing of the waste entry door.

4. The container of claim 2, further comprising waste compaction means within the waste storage compartment for compacting received waste.

5. The container of claim 2, further comprising one or more waste vehicle lifting arm receptacles on one or more outer surfaces of the waste storage compartment.

6. The container of claim 2, wherein the payment activated means comprise one or more payment means selected from the following payment means: coin-operated payment, pre-paid token operated payment, currency payment, credit card payment, debit card payment, smart card payment, pre-paid cash card payment, smart phone wireless payment, and third party billing payment.

7. The container of claim 2, wherein the receiving compartment has a volume sufficient to receive up to 80 cubic yards of waste.

8. The container of claim 2, wherein the receiving compartment has a volume sufficient to receive up to 20 cubic yards of waste.

9. The container of claim 2, wherein the receiving compartment has a volume sufficient to receive up to 1 cubic yard of waste.

10. A user pay waste disposal system comprising a plurality of the user pay waste disposal containers of claim 2, a network of container access sites, and one or more waste disposal vehicles for removal of waste from containers at each access site for transport to a landfill or other waste receiving site.

11. A user pay waste disposal system comprising a plurality of the user pay waste disposal containers of claim 2, a network of container access sites, and one or more waste disposal vehicles for removal of waste from containers at each access site for transport to a landfill or other waste receiving site.

12. A method of waste disposal comprising:
a. distributing one or more of the user pay waste disposal containers of claim 1 to one or more container access sites;
b. allowing users to deposit a permitted volume of waste into a container through payment of a tariff by a selected mode of payment at the container;
c. compacting and storing the deposited waste within the container;
d. transferring the stored waste into a waste disposal vehicle; and
e. transporting the waste to a landfill or other waste receiving site.

13. The method of claim 12, wherein the mode of payment is selected from the group of payment modes comprising: coin-operated payment, pre-paid token operated payment, currency payment, credit card payment, debit card payment, smart card payment, pre-paid cash card payment, smart phone wireless payment, and third party billing payment.
